(19) United States
(12) Patent Application Publication
(10) Pub. No.: US 2025/0249737 A1
(43) Pub. Date: Aug. 7, 2025

(54) VEHICLE

(71) Applicant: TOYOTA JIDOSHA KABUSHIKI KAISHA, Toyota-shi (JP)

(72) Inventor: Tomoki SAKATA, Toyota-shi (JP)

(73) Assignee: TOYOTA JIDOSHA KABUSHIKI KAISHA, Toyota-shi (JP)

(21) Appl. No.: 18/939,541

(22) Filed: Nov. 7, 2024

(30) Foreign Application Priority Data
Feb. 5, 2024 (JP) 2024-015825

(51) Int. Cl. B60K 6/405

(52) U.S. Cl. CPC B60K 6/405; B60Y 2200/92

(57) ABSTRACT

The vehicle includes, in the engine compartment, an engine unit fixed to the vehicle body, a motor unit fixed to the vehicle body together with the engine unit, a power conversion unit fixed on the motor unit, a charging unit fixed on the power conversion unit, and a stiffener connecting the power conversion unit and the engine unit to each other. The stiffener has at least one first end fixed to the power conversion unit and at least one second end fixed to the engine unit. The casing of the power conversion unit is provided with a boss for fixing the charging unit. The first end of the stiffener is fixed to the boss of the power conversion unit.

### CROSS-REFERENCE TO RELATED APPLICATION

This application claims priority to Japanese Patent Application No. 2024-015825 filed on Feb. 5, 2024, incorporated herein by reference in its entirety.

### BACKGROUND

### 1. Technical Field

The technique disclosed herein relates to a vehicle.

### 2. Description of Related Art

Japanese Unexamined Patent Application Publication No. 2016-22799 (JP 2016-22799 A) discloses a vehicle. In this vehicle, a power conversion unit and a charging unit are sequentially stacked on a motor unit.

### SUMMARY

In the vehicle described above, the charging unit is fixed to a vehicle body via the power conversion unit and the motor unit. With such a configuration, the stability (rigidity) of the charging unit with respect to the vehicle body may become insufficient. In this case, the charging unit may vibrate while the vehicle is traveling, or the charging unit may be largely displaced at the time of a collision of the vehicle. The present specification provides a technique for solving these problems.

The technique disclosed herein is embodied in a vehicle. In a first aspect of the present technique,
a vehicle includes:
a vehicle body that has an engine compartment;
an engine unit that is fixed to the vehicle body in the engine compartment;
a motor unit that is fixed to the vehicle body together with the engine unit in the engine compartment;
a power conversion unit that is fixed on the motor unit in the engine compartment;
a charging unit that is fixed on the power conversion unit in the engine compartment; and
a stiffener that connects the power conversion unit and the engine unit to each other in the engine compartment,
wherein
the stiffener has at least one first end fixed to the power conversion unit and at least one second end fixed to the engine unit,
a casing of the power conversion unit is provided with a boss for fixing the charging unit, and
the first end of the stiffener is fixed to the boss of the power conversion unit.

In the vehicle described above, the power conversion unit and the engine unit are connected to each other using the stiffener. In particular, the stiffener is fixed to the boss for fixing the charging unit in the casing of the power conversion unit. According to such a configuration, it is not necessary to newly provide a boss for fixing the stiffener in each of the power conversion unit and the charging unit. In addition, the boss for fixing the charging unit provided on the power conversion unit serves as a portion that is firmly connected to their units. Fixing the stiffener to the boss enables both of the power conversion unit and the charging unit to be firmly connected to the engine unit fixed to the vehicle body. The stability (rigidity) of the charging unit with respect to the vehicle body can be improved to suppress vibration of the charging unit and large displacement of the charging unit.

In a second aspect of the present technique, in addition to the first aspect,
the casing of the power conversion unit may include a casing body having an opening opened upward, and a casing cover attached to the opening, and
the boss may be integrally provided with the casing cover. For example, the casing cover and the boss may be a single die cast member made of an aluminum-based metal or another metallic material.

In a third aspect of the present technique, in addition to the second aspect,
the boss may extend upward from the casing cover,
the charging unit may be fixed to an upper end of the boss, and
the first end of the stiffener may be fixed to a side surface of the boss. When the charging unit and the stiffener are fixed to different positions in the boss, the stiffener can be freely designed without affecting the fixing structure between the charging unit and the stiffener. In addition, fixing the charging unit to the boss and fixing the stiffener to the boss can be performed in any order.

In a fourth aspect of the present technique, in addition to any one of the first to third aspects,
the stiffener may include a first member having the first end and a second member having the at least one second end and detachably connected to the first member. According to such a configuration, before the power conversion unit and the engine unit are assembled to each other, a part (first member) of the stiffener can be fixed to the power conversion unit, and another part (second member) of the stiffener can be fixed to the engine unit. Therefore, even in a configuration in which the power conversion unit and the engine unit are adjacent to each other, a fixing portion of the stiffener can be freely designed in each unit.

In a fifth aspect of the present technique, in addition to any one of the first to fourth aspects,
the stiffener may further have a third end to which a pipe or wiring is attached. According to such a configuration, it is possible to fix the pipe or the wiring located between the power conversion unit and the engine unit, which making it possible to improve convenience.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view schematically illustrating a configuration of a vehicle;

FIG. 2 is a cross-sectional view of a vehicle showing a positional relationship of each unit;

FIG. 3 is an enlarged view of the section shown in III of FIG. 2;

FIG. 4 is a diagram illustrating a configuration of a stiffener;

FIG. 5 is a cross-sectional view taken along V-V line of FIG. 4, showing the positional relation between the brackets and the bosses; and

FIG. 6 is a diagram illustrating a modification of the stiffener.

### DETAILED DESCRIPTION OF EMBODIMENTS

A vehicle 10 according to an embodiment will be described with reference to the drawings. The vehicle 10 of the present embodiment is a plug-in hybrid electric vehicle (PHEV). However, the vehicle 10 is not limited to a plug-in hybrid electric vehicle, and may be a hybrid electric vehicle (HEV).

Here, the direction FR in the drawing indicates the front in the vehicle front- rear direction, and the opposite direction indicates the rear in the vehicle front-rear direction. Further, the direction LH indicates the left in the vehicle left-right direction (or the widthwise direction), and the opposite direction indicates the right in the vehicle left-right direction. The direction UP indicates an upward direction in the vehicle up-down direction, and the opposite direction indicates a downward direction in the vehicle up-down direction. In this specification, the front side in the vehicle front-rear direction and the rear side in the vehicle front-rear direction may be simply referred to as the front side and the rear side, respectively. Further, the left side in the vehicle left-right direction and the right side in the vehicle left-right direction may be simply referred to as the left side and the right side, respectively. Further, the upper side in the vehicle up-down direction and the lower side in the vehicle up-down direction may be simply referred to as the upper side and the lower side, respectively.

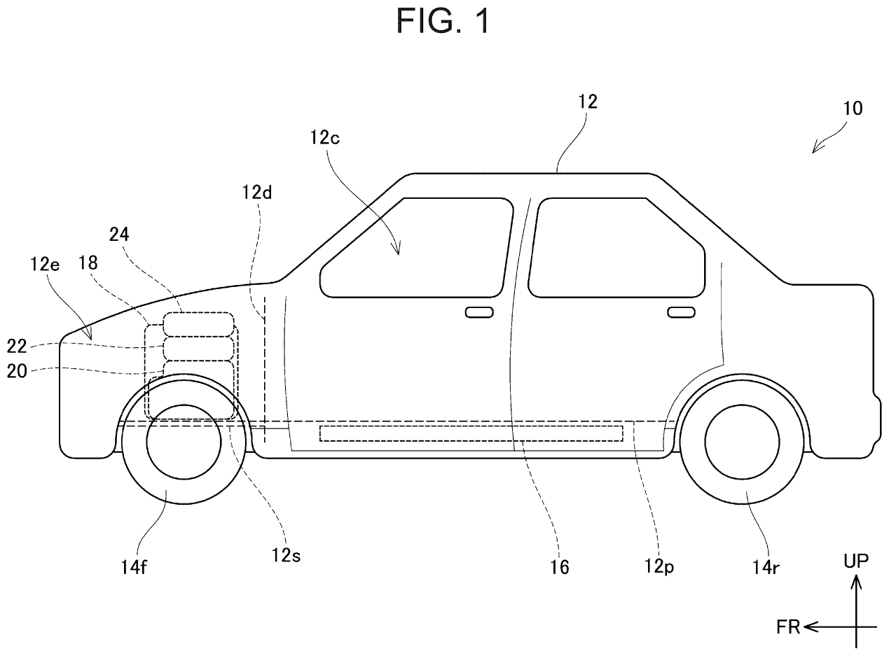

As illustrated in FIG. 1, the vehicle 10 includes a vehicle body 12 and a plurality of wheels 14f, 14r. The vehicle body 12 is made of a metal such as a steel-based material or an aluminum-based material. The plurality of wheels 14f, 14r supports the vehicle body 12. The plurality of wheels 14f, 14r includes a pair of front wheels 14f located at a front portion of the vehicle body 12 and a pair of rear wheels 14r located at a rear portion of the vehicle body 12. The pair of front wheels 14f are respectively located on the left and right sides of the vehicle body 12. The pair of rear wheels 14r are respectively located on the left and right sides of the vehicle body 12.

A cabin 12c and an engine compartment 12e located in front of the cabin 12c are defined inside the vehicle body 12. The cabin 12c is configured to allow a user to board. The vehicle body 12 includes a floor panel 12p, a dash panel 12d, and a suspension member 12s. The floor panel 12p defines a floor of the cabin 12c. A dash panel 12d is interposed between the cabin 12c and the engine compartment 12e. The suspension member 12s is arranged in the engine compartment 12e. The suspension member 12s is a member that supports front suspensions (not shown) of the left and right front wheels 14f. The suspension member 12s is attached to a part of the vehicle body 12 in the engine compartment 12e. Although not particularly limited, the rear end of the suspension member 12s is fixed to the dash panel 12d.

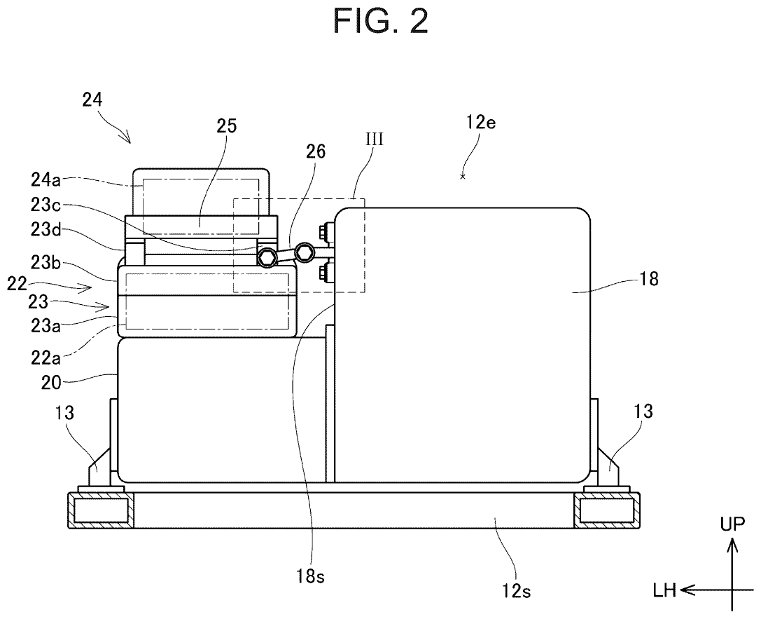

As illustrated in FIGS. 1 and 2, the vehicle 10 includes a battery 16, an engine unit 18, a motor unit 20, a power control unit (PCU) 22, a charging unit 24, and a stiffener 26.

The battery 16 is disposed below the floor panel 12p. The battery 16 includes one or a plurality of secondary battery cells and is configured to be chargeable and dischargeable. The secondary battery cell is not particularly limited, but may be, for example, a lithium-ion battery cell or an all-solid-state battery cell.

The engine unit 18 is a heat engine that burns fuel to generate power, and is not particularly limited, and examples thereof include a gasoline engine, a diesel engine, and a hydrogen engine. The engine unit 18 is connected to a pair of front wheels 14f via a speed reducer and a power split mechanism (not shown). The engine unit 18 drives a pair of front wheels 14f. The engine unit 18 is arranged in the engine compartment 12e. The engine unit 18 is fixed on the suspension member 12s of the vehicle body 12.

The motor unit 20 includes a traveling motor (not shown). The motor unit 20 is connected to the battery 16 via a PCU 22. The motor unit 20 is connected to a pair of front wheels 14f. The motor unit 20 drives a pair of front wheels 14f using electric power supplied from the battery 16. However, the motor unit 20 is not limited to the pair of front wheels 14f, and may drive at least one of the plurality of wheels 14f, 14r. The motor unit 20 is arranged in the engine compartment 12e. The motor unit 20 is adjacent to the engine unit 18 and is integrated with the engine unit 18. The motor unit 20 is fixed to the suspension member 12s together with the engine unit 18 via brackets 13.

PCU 22 includes a power control device 22a including an inverter circuit, a converter circuit, and the like. PCU 22 is electrically connected to the battery 16 and the motor unit 20, respectively. PCU 22 controls the power supplied between the battery 16 and the motor unit 20. Alternatively, when the vehicle 10 decelerates, PCU 22 controls the regenerative power supplied from the motor unit 20 to the battery 16. PCU 22 may be disposed on the engine compartment 12e and above the motor unit 20. PCU 22 is disposed on the motor unit 20 and is integrally fixed to the motor unit 20.

The charging unit 24 has a charger 24a. The charger 24a is, for example, a bi-directional charger. The charging unit 24 is electrically connected to the battery 16 and other electrical units of the vehicle 10, respectively. The charging unit 24 controls the supply power to and from the battery 16 or other electrical unit. Other electric units include, for example, a charge inlet, a feed inlet in a cabin 12c, and the like. The charging unit 24 is disposed on PCU 22 and is integrally fixed to PCU 22. Specifically, the charging unit 24 has a casing 24b that houses the charger 24a. The casing 24b is a housing member. A plurality of brackets 25 is attached to the lower portion of the casing 24b. The charging unit 24 is fixed to PCU 22 via a plurality of brackets 25.

Referring to FIGS. 2, 3, and 5, PCU 22 and the charging unit 24 will be described in detail. As shown in FIGS. 2, 3 and 5, PCU 22 has a casing 23 in which the power control device 22a is housed. The casing 23 is made of metal. The metal constituting the casing 23 may be an aluminum-based metal or another metal. The casing 23 has a casing body 23a and a casing cover 23b. The casing body 23a is a casing member in which a power control device 22a is disposed. The casing body 23a has an opening opened upward. The casing cover 23b is attached to an opening of the casing body 23a.

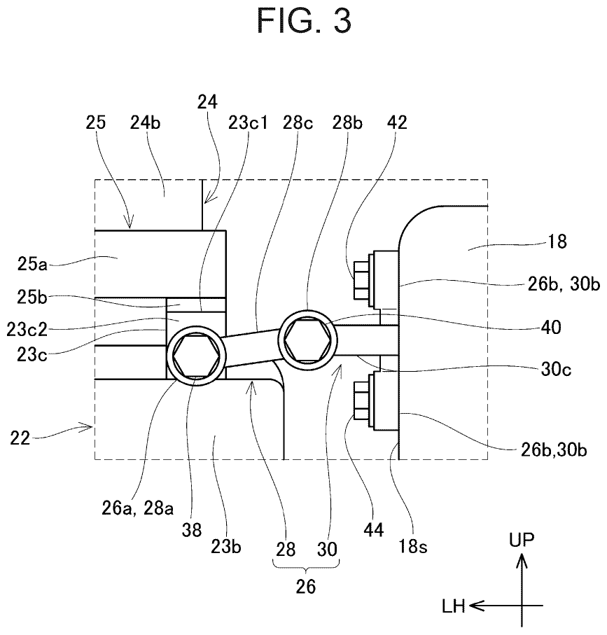

The casing cover 23b is provided with a plurality of bosses 23c, 23d. The plurality of bosses 23c, 23d is coupling parts that fix the charging unit 24. Although not particularly limited, the plurality of bosses 23c, 23d is integrally formed on the casing cover 23b. The plurality of bosses 23c, 23d extends upward toward the charging unit 24, and the charging unit 24 is fixed to the upper ends of the plurality of bosses 23c, 23d (for example, 23c1 in FIG. 3) via the plurality of brackets 25. A gap is provided between PCU 22 casing cover 23b and the charging unit 24.

The pair of bosses 23c, 23d illustrated in FIG. 2 is located at the rear end of the casing cover 23b. The casing cover 23b is provided with a pair of bosses (not shown) located at the front end of the casing cover 23b in addition to the bosses 23c, 23d. Hereinafter, one boss 23c shown in FIG. 3 is referred to as a first boss 23c. The first boss 23c has an upper end 23c1 and a side surface 23c2 extending in a cylindrical shape between the casing cover 23b and the upper end 23c1 of the first boss 23c. The other boss 23d have the same configuration.

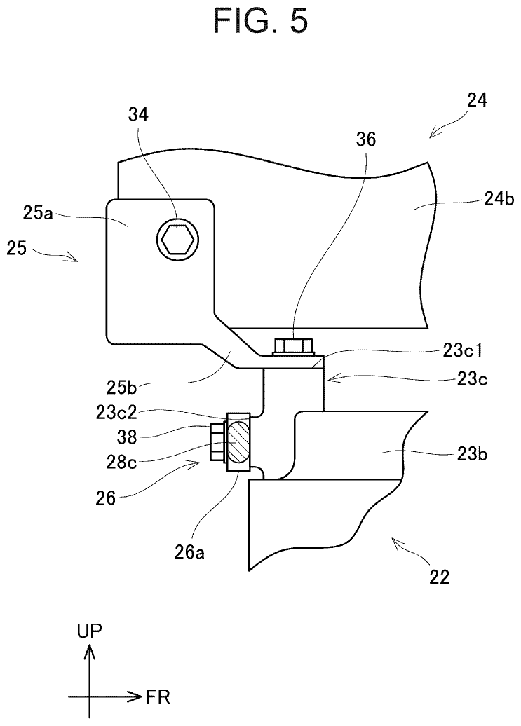

Although not particularly limited, as shown in FIG. 5, each of the plurality of brackets 25 is a bent plate-like member. The plurality of brackets 25 is disposed at both ends of the charging unit 24 in the front-rear direction. The bracket 25 located at the rear end of the charging unit 24 has a bracket body 25a and a pair of leg portions 25b. The bracket body 25a is fixed to the casing 24b of the charging unit 24 by the fastening member 34. The pair of leg portions 25b are located at the left and right ends of the bracket body 25a. One of the pair of leg portions 25b extends from the bracket body 25a toward a first boss 23c provided in the casing cover 23b of PCU 22. One of the pair of leg portions 25b is fastened to the upper end 23c1 of the boss 23c by a fastening member 36. The other of the pair of leg portions 25b is likewise fastened to the other boss 23d. The bracket located on the front end side of the charging unit 24 is configured similarly to the bracket 25 on the rear end side, and has a bracket body and a pair of leg portions. Therefore, the bracket fixes the charging unit 24 and the pair of bosses located on the front end side of the casing cover 23b of PCU 22 to each other, similarly to the bracket 25 located on the rear end side.

The stiffener 26 is a connecting member that connects PCU 22 and the engine unit 18 to each other in the engine compartment 12e. The stiffener 26 has a first end 26a fixed to PCU 22 and two second end 26b fixed to the engine unit 18. The first end 26a of the stiffener 26 is fixed to the first boss 23c of PCU 22. Although not particularly limited, the first end 26a of the stiffener 26 is fixed to the side surface 23c2 of the first boss 23c by the fastening member 38. On the other hand, the charging unit 24 is fixed to the upper end 23c1 of the first boss 23c by a fastening member 36 (shown in FIG. 5). In this way, when the charging unit 24 and the stiffener 26 are fixed at different positions in the boss 23c, the stiffener 26 can be freely designed without affecting the fixing structure between the charging unit 24 and the stiffener 26. In addition, the step of securing the charging unit 24 to the boss 23c, 23d and the step of securing the stiffener 26 to the first boss 23c can be performed in any order.

Note that the side surface 23c2 of the first boss 23c has a flat surface as far as the stiffener 26 is fixed. However, the first end 26a of the stiffener 26 may be fixed to the boss located on the front end side of the casing cover 23b without being limited to the first boss 23c located on the rear end side of the casing cover 23b. In that case, the boss may have a flat surface.

On the other hand, the two second end 26b of the stiffener 26 are fixed to the side surface 18s of the engine unit 18 by fastening members 42 and 44, respectively. The side surface 18s of the engine unit 18 faces PCU 22 in the left-right direction, and the two second end 26b of the stiffener 26 are located between PCU 22 and the engine unit 18. In an exemplary embodiment, the two second end 26b of the stiffener 26 may be fixed to a housing part of the engine unit 18, such as a cylinder block. Note that the number of second end 26b is not limited to two. The stiffener 26 may have at least one second end 26b secured to the engine unit 18.

In the vehicle 10 according to the present embodiment, PCU 22 and the engine unit 18 are connected to each other using the stiffener 26. In particular, the stiffener 26 is fixed in the casing 23 of PCU 22 to a first boss 23c which fixes the charging unit 24. According to such a configuration, there is no need to newly provide another boss for fixing the stiffener 26 to PCU 22 and the charging unit 24. In addition, the first boss 23c for fixing the charging unit 24 provided in PCU 22 is a part which is firmly connected to the units 22 and 24. By fixing the stiffener 26 to the first boss 23c, both PCU 22 and the charging unit 24 can be firmly connected to the engine unit 18 fixed to the vehicle body 12. The stability (rigidity) of the charging unit 24 with respect to the vehicle body 12 is improved, so that vibration of the charging unit 24 and large displacement of the charging unit 24 are suppressed. Here, PCU 22 in the present embodiment is an example of a “power converting unit” in the present technique.

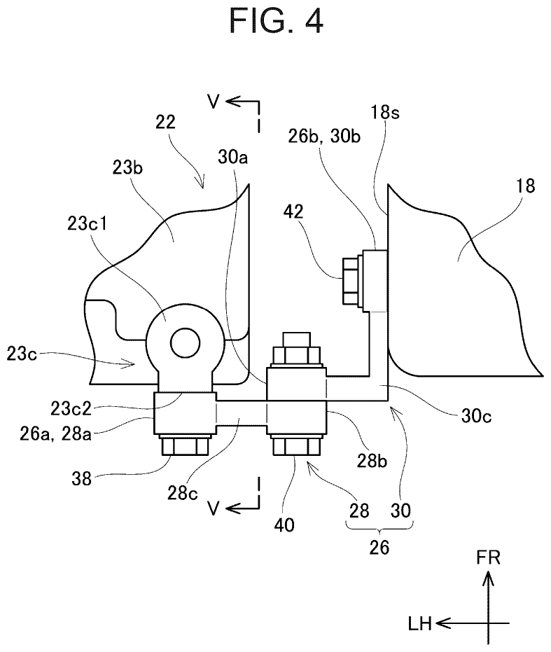

The details of the configuration of the stiffener 26 will be described with reference to FIGS. 3 to 5. As illustrated in FIGS. 3 to 5, the stiffener 26 includes a first member 28 and a second member 30 detachably connected to the first member 28. The first member 28 is provided with a first end 26a fixed to the first boss 23c of PCU 22. The second member 30 is provided with a second end 26b fixed to the engine unit 18. According to such a configuration, prior to assembling PCU 22 and the engine unit 18 to each other, a part of the stiffener 26 (the first member 28) may be fixed to the power converting unit, and another part of the stiffener 26 (the second member 30) may be fixed to the engine unit 18. Therefore, even in a configuration in which PCU 22 and the engine unit 18 adjoin each other, a fixed portion of the stiffener 26 can be freely designed in each of the units 22 and 18.

In addition to the first end 26a fixed to PCU 22, the stiffener 26 in the present embodiment has a first connection end 28b connected to the second member 30. The second member 30 has a second connection end 30a connected to the first member 28 in addition to two second end 26b fixed to the engine unit 18. That is, the first connection end 28b of the first member 28 and the second connection end 30a of the second member 30 are connected to each other by the fastening member 40. The first member 28 has a first extending portion 28c extending in a rod shape between the first end 26a and the first connection end 28b. The second member 30 has a second extending portion 30c connecting the two second end 26b and the second connection end 30a to each other. The second extending portion 30c branches from the second connection end 30a to the two second end 26b. The first end 26a and the two second end 26b of the stiffener 26 are fixed to PCU 22 or the engine unit 18 by fastening members 38 and 42. Note that reference numeral 28a, 30b in the drawings indicates respective end portions of the first member 28 or the second member 30.

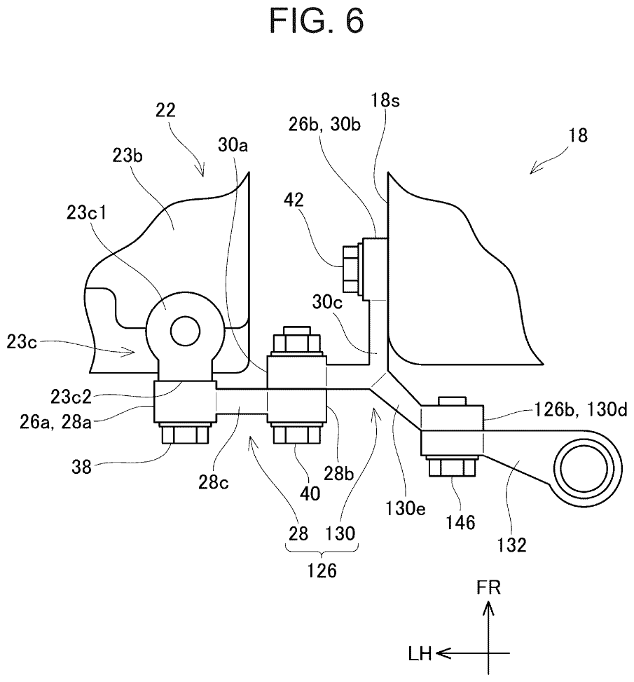

The stiffener 26 is not limited to the configuration described above. FIG. 6 illustrates a stiffener 126 according to a modification. The stiffener 126 has a third end 126b in addition to the first end 26a and the second end 26b described above. A fastening member 146 may be used to attach the piping component 132 to the third end 126b. The piping component 132 may form part of a cooling line for cooling PCU 22 and/or the engine unit 18. According to such a configuration, a cooling pipe for cooling PCU 22 and the engine unit 18 can be easily fixed at a position between them. However, as another embodiment, a wire component may be attached to the third end 126b. The wiring component may form part of a wiring connected to PCU 22 and/or the engine unit 18.

The position of the third end 126b is not particularly limited. The third end 126b may be provided on the first member 28 or the second member 130 of the stiffener 26. In one embodiment, the stiffener 126 of this modification, the third end 126b is provided on the second member 130, the branch portion 130e branched from the second extending portion 30c extends toward the third end 126b. That is, the third end 126b is located on the distal end 130d of the branch portion 130e.

What is claimed is:

1. A vehicle comprising:
a vehicle body that has an engine compartment;
an engine unit that is fixed to the vehicle body in the engine compartment;
a motor unit that is fixed to the vehicle body together with the engine unit in the engine compartment;
a power conversion unit that is fixed on the motor unit in the engine compartment;
a charging unit that is fixed on the power conversion unit in the engine compartment; and
a stiffener that connects the power conversion unit and the engine unit to each other in the engine compartment, wherein
the stiffener has at least one first end fixed to the power conversion unit and at least one second end fixed to the engine unit,
a casing of the power conversion unit is provided with a boss for fixing the charging unit, and
the first end of the stiffener is fixed to the boss of the power conversion unit.

2. The vehicle according to claim 1, wherein:
the casing of the power conversion unit includes a casing body having an opening opened upward, and a casing cover attached to the opening; and
the boss is integrally provided with the casing cover.

3. The vehicle according to claim 2, wherein:
the boss extends upward from the casing cover;
the charging unit is fixed to an upper end of the boss; and
the first end of the stiffener is fixed to a side surface of the boss.

4. The vehicle according to claim 1, wherein the stiffener includes a first member having the first end and a second member having the at least one second end and detachably connected to the first member.

5. The vehicle according to claim 1, wherein the stiffener further has a third end to which a pipe or wiring is attached.
